(19) United States
(12) Patent Application Publication
(10) Pub. No.: US 2019/0178385 A1
(43) Pub. Date: Jun. 13, 2019

(54) MECHANICAL SEAL DEVICE WITH A SIMPLIFIED STRUCTURE

(71) Applicant: EagleBurgmann Germany GmbH & Co. KG, Wolfratshausen (DE)

(72) Inventors: Josef Gerg, Gaissach (DE); Benjamin Hamm, Oberau (DE)

(21) Appl. No.: 16/074,293

(22) PCT Filed: Jan. 16, 2017
(86) PCT No.: PCT/EP2017/050766

§ 371 Date: Jul. 31, 2018

(30) Foreign Application Priority Data
Feb. 2, 2016 (DE) 10 2016 201 538.9

(51) Int. Cl. F16J 15/34

(52) U.S. Cl. CPC F16J 15/3464

(57) ABSTRACT

The invention relates to a mechanical seal device (1), comprising a rotating slide ring (2) and a stationary slide ring (3) that define a sealing gap (4) in between them, a retaining ring (5) for retaining the stationary slide ring (3), a housing (6) with a side that is oriented towards a product side (13) and a side that is oriented towards an atmospheric side (14), and a clamping mechanism (8), wherein a clamp connection is formed between the housing (6) and the retaining ring (5) by means of the clamping mechanism (8), wherein the housing (6) has at least one through hole (60) that connects the side of the housing that is oriented towards the product side (13) with the side of the housing that is oriented towards the atmospheric side (14), wherein the clamping mechanism (8) has a screw bolt (80) and a clamping element (82), wherein the screw bolt (80) is arranged in the through hole (60) of the housing (6), and the clamping element (82) has a threaded opening (83) into which the screw bolt (80) is screwed, and wherein the clamping element (82) has a contact surface (84) that abuts at the retaining ring (5) to form the clamp connection.

The present invention relates to a mechanical seal device with a simplified structure, wherein in particular a disassembly of the mechanical seal device can be carried out easily from an atmospheric side.

Mechanical seal devices are known from the state of the art in various embodiments. What is known from DE 1 0201 30071 65 B4, for example, is a mechanical seal device that has a retaining ring for retaining a stationary slide ring, wherein the retaining ring is connected to a housing by means of a clamp connection. At that, the clamp connection is arranged at a product side of the mechanical seal device. In this manner, necessary supply lines can be arranged freely inside the housing, whereby in particular most varied kinds of customers' wishes can be realized when it comes to the arrangement of such supply lines. At that, the mechanical seal device is mounted in the axial direction on a shaft or the like. After a certain number of operating hours, it may be necessary to replace the slide rings and other wear parts of the mechanical seal device. Here, it has been found that clotting from the product may occur at the clamp connection and/or at the shaft sleeve, for example if the mechanical seal device is used in pumps with an extremely sticky product at a product side, such as e.g. concrete or tar, or the like. This may result in difficulties when the mechanical seal device is being pulled off in the axial direction. Here, the mechanical seal device can often be detached from the shaft only by excessive force and/or with some destruction occurring.

Therefore, it is the objective of the present invention to provide a mechanical seal device which in particular facilitates disassembly from an atmospheric side in all application cases, while at the same time having a simple structure as well as a simple, cost-effective manufacturability, with it still being possible to arrange the supply lines of the mechanical seal device inside a housing as freely as possible.

The objective is achieved through a mechanical seal device having the features of claim 1, with the subclaims showing preferred further developments of the invention.

The mechanical seal device according to the invention with the features of claim 1 comprises at least one mechanical seal with a rotating and a stationary slide ring that delimit a sealing gap in between them. What is further provided is a retaining ring for retaining the stationary slide ring. Further, the mechanical seal device comprises a housing, wherein a clamp connection by means of a clamping mechanism is provided between the housing and the retaining ring. To achieve accessibility to the clamp connection from an atmospheric side, at least one axial through hole is provided inside the housing, connecting the product side of the housing to the atmospheric side of the housing. Here, the clamping mechanism comprises a screw bolt and a clamping element, wherein the screw bolt is arranged inside the passage opening. The clamping element has a threaded opening into which the screw bolt is screwed in, wherein the clamping element is further embodied in such a manner that a contact surface of the clamping element abuts the retaining ring to form the clamp connection. Thus, it is possible to screw the screw bolt in and also to screw it out again from the atmospheric side. In this manner, also a partial disassembly from the atmospheric side is possible if the mechanical seal device cannot be pulled off the shaft or the like in the axial direction as a result of clotting by a product to be sealed, or the like. By loosening the screw bolt, the housing of the mechanical seal device can be removed, and subsequently further individual parts of the mechanical seal device can be simply dismantled.

For a particularly easy disassembly, the screw bolt has a head with a tool attachment projection at an end that is located at the atmospheric side.

Further, the housing preferably has a recess inside of which the clamping element is arranged. In this manner, a very compact design can be obtained in the axial direction of the mechanical seal device. Further, the use of the recess facilitates that the clamping element is stopped from rotating, e.g. due to geometrical stop surfaces or the like, when the screw bolt is screwed into the clamping element.

To avoid any twisting of the clamping element as the screw bolt is being screwed in and/or screwed out, the clamping element has a threaded opening, with its central axis being arranged so as to be offset with respect to a center line of the clamping element.

The clamping element is preferably a sliding block, wherein the threaded opening in the clamping element is completely passed through the sliding block in the axial direction. It is especially preferred if the sliding block is formed in a cylindrical manner and the threaded opening in the sliding block is provided off center with respect to a central axis of the sliding block. Alternatively the sliding block can also be embodied as a square or a hexagon, or in general as a polygon. The sliding block can also have one or two oppositely arranged contact surfaces for abutting the housing so as to avoid any co-rotation of the sliding block during a screwing process.

The housing of the mechanical seal device preferably consist of a single part. In this manner, the most varied arrangements of supply channels inside the housing can be realized, which makes it possible to meet special customers' wishes.

It is particularly preferred if at least one supply line, preferably two supply lines, namely one supply line and one return line for a barrier fluid or the like, are provided inside the housing.

It is particularly preferred if the mechanical seal device is provided as a cartridge, i.e. as a unit that can be pre-assembled. In this manner, it is in particular ensured that the mechanical seal device can be mounted on a shaft or the like in a particularly quick manner.

Further, it is particularly preferred if multiple clamping mechanisms are arranged along a circumference, in particular if they are arranged equidistantly in the circumferential direction.

To provide a protection, in particular for the slide rings of the mechanical seal device, the housing preferably extends over the slide rings.

Here, the mechanical seal device according to the invention can be provided as a simple mechanical seal device, i.e. having exactly one mechanical seal, or alternatively also as a double mechanical seal device with two separate mechanical seals.

The mechanical seal device is preferably used in applications with pumps.

Further, the present invention relates to a pump for pumping viscous and/or sticky media with a mechanical seal device according to the invention.

In the following, a preferred exemplary embodiment of the invention is described in more detail by referring to the accompanying drawing. In the drawings:

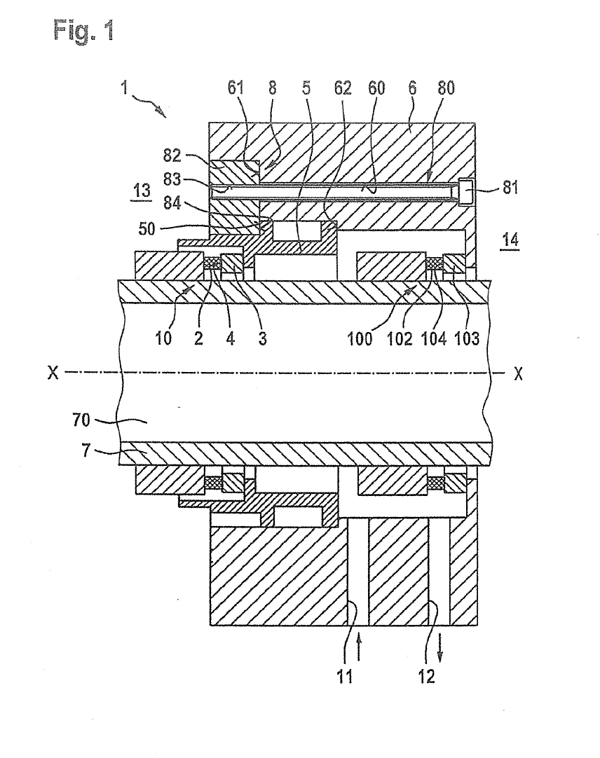

FIG. 1 shows a schematic sectional view of a mechanical seal device according to an exemplary embodiment of the invention, and

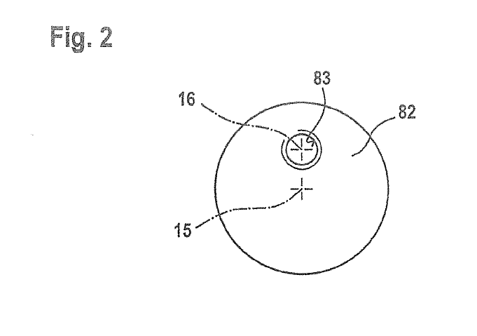

FIG. 2 shows a schematic top view on a clamping element of the mechanical seal device of FIG. 1.

In the following, a mechanical seal device 1 according to a preferred exemplary embodiment of the invention is described in detail based on FIGS. 1 and 2.

As can be seen in FIG. 1, the mechanical seal device 1 comprises a first mechanical seal 10 and a second mechanical seal 100. The first mechanical seal 10 comprises a rotating slide ring 2 and a stationary slide ring 3 that delimit a sealing gap 4 in between them. The second mechanical seal 100 comprises a rotating slide ring 102 and a stationary slide ring 103 that delimit a sealing gap 104 in between them.

The mechanical seal device 1 seals a product side 13 off against an atmospheric side 14 at the shaft 70.

The mechanical seal device is preferably used in a pump, or the like.

As can be seen in FIG. 1, the mechanical seal device is mounted on a shaft sleeve 7. The mechanical seal device 1 is provided as a cartridge, so that the mechanical seal device 1 can be preassembled on the shaft sleeve 7 and can be simply slid onto the shaft 70 in the axial direction X-X of the shaft.

The mechanical seal device 1 further comprises a retaining ring 5 that retains the stationary slide ring 3 of the first slide ring seal 10.

Further, the mechanical seal device 1 comprises a single-part housing 6 that extends over the two mechanical seals 10, 100 in the axial direction X-X. By providing the single-part housing 6, the supply lines, such as e.g. the first media duct 11 and the second media duct 12 indicated in FIG. 1, can be arranged in the housing 6 in any desired manner as in comparison to mechanical seal devices having a divided housing, with the housing comprising at least two parts.

The retaining ring 5 is fixated at the housing 6 by means of a clamp connection. The clamp connection is provided by a clamping mechanism 8, comprising a screw bolt 80 and a clamping element 82.

As can be seen in FIG. 1, a through hole 60 is provided in the housing 6, extending in the axial direction X-X in the housing from a product side 13 to an atmospheric side 14.

Further, a recess 61 is provided in the housing 6 to receive the clamping element 82. The screw bolt 80 is passed through the through hole 60 inside the housing 6.

The screw bolt 80 comprises a cylindrical body provided with a thread, as well as a head 81, with the head 81 being oriented towards the atmospheric side 14 and being arranged in the housing 6 in a countersunk manner.

As can be seen in FIG. 1, the retaining ring 5 is clamped between a ledge 62 of the housing 6 and the clamping element 82. Here, the clamping element 82 has a threaded opening 83 into which the screw bolt 80 is screwed in. The clamping element 82 further comprises a contact surface 84 which abuts the retaining ring 5 at a clamping surface 50.

As can be seen in FIG. 1, the retaining ring 5 is thus clamped between the contact surface 84 and the ledge 62 in the housing 6. Here, the clamping process can be carried out by screwing the screw bolt 80 into the threaded opening 83 of the clamping element 82. In this manner, the clamping element 82 is pulled in the direction towards the atmospheric side 14, so that the clamp connection is realized.

Because the head 81 of the screw bolt 80 is arranged at the atmospheric side 14, the housing 6 can be detached from the retaining ring 5 from the direction of the atmospheric side 14. This is for example necessary when wear parts have to be maintained and/or replaced, such as e.g. in the case of a replacement of the slide rings or the like. At that, the screw bolt 80 can be screwed out of the clamping element 82 at a tool attachment projection formed at the head 81.

FIG. 2 schematically shows a top view on the clamping element 82. As can be seen in FIG. 2, a central axis 16 of the threaded opening 83 is arranged so as to be offset with respect to a center line 15 of the clamping element 82. The clamping element 82 of this exemplary embodiment is a cylindrical element, e.g. a cylindrical sliding block.

Since the threaded opening 83 is arranged off center in the cylindrical clamping element 82, a co-rotation of the clamping element 82 can be avoided as the screw bolt 80 is being screwed in or out of the threaded opening 83. Here, the clamping element always abuts the walls of the recess 61 inside the housing 6.

If a maintenance procedure becomes due in the mechanical seal device according to the invention, the disassembly of the mechanical seal device 1 can be carried out in a simple manner from the atmospheric side 14 if it should not be possible to pull off the complete mechanical seal device from the shaft 70 in the axial direction X-X. This may in particular occur if the product to be sealed is for example very sticky or very viscous, such as e.g. concrete or tar, or the like. If thus the mechanical seal device cannot be completely pulled off, the screw bolts 80 can be loosened, and at first the housing 6 can be dismounted and subsequently the further individual parts of the slide ring seal can be correspondingly removed.

Thus, according to the invention, a maintenance procedure of mechanical seal devices can be rendered considerably easier, without having to accept the disadvantages of a divided housing.

By providing the clamp connection between the single-part housing 6 and the retaining ring 5, a secure connection of the housing can thus be facilitated, and in particular an embodiment of the mechanical seal device as a cartridge, which has advantages with respect to mounting and offers security against any damage to sensitive components of the mechanical seal device, can be provided.

Further, the housing 6 covers the two slide ring seals 10, 100 in the axial direction. Here, it should be understood that it is not absolutely necessary that a tandem arrangement with two mechanical seals be provided, but rather that it is also possible to provide only one individual mechanical seal.

### PARTS LIST

1 mechanical seal device

2 rotating slide ring

3 stationary slide ring

4 sealing gap

5 retaining ring

6 housing

7 shaft sleeve

8 clamping mechanism

10 first slide ring seal

11 first media duct

12 second media duct

13 product side

14 atmospheric side

15 center line

16 central axis

50 clamping surface

60 through hole

61 recess in the housing

62 ledge

70 shaft

80 screw bolt

81 head

82 clamping element

83 threaded opening

84 contact surface

100 second mechanical seal

102 rotating slide ring

103 stationary slide ring

104 sealing gap

X-X axial direction

1. Mechanical seal device, comprising:
a rotating slide ring and a stationary slide ring that define a sealing gap in between them,
a retaining ring for retaining the stationary slide ring,
a housing with a side that is oriented towards a product side and a side that is oriented towards an atmospheric side, and
a clamping mechanism,
wherein a clamp connection is formed between the housing and the retaining ring by means of the clamping mechanism,
wherein the housing has at least one through hole that connects the side of the housing that is oriented towards the product side to the side of the housing that is oriented towards the atmospheric side,
wherein the clamping mechanism has a screw bolt and a clamping element,
wherein the screw bolt is arranged in the through hole of the housing,
wherein the clamping element has a threaded opening into which the screw bolt is screwed, and
wherein the clamping element has a contact surface that abuts at the retaining ring to form the clamp connection.

2. Device according to claim 1, wherein a head of the screw bolt has a tool attachment projection that is oriented towards the atmospheric side.

3. Device according to claim 1, wherein the clamping element is arranged in a recess inside the housing.

4. Device according to claim 1, wherein the clamping element has a center line that extends in the axial direction, and the threaded opening of the clamping element has a central axis that is arranged so as to be offset with respect to the center line.

5. Device according to claim 1, wherein the clamping element is a sliding block.

6. Device according to claim 5, wherein the sliding block is cylindrical and the threaded opening is arranged off-center with respect to the center line of the sliding block, or that the sliding block is a polygon.

7. Device according to claim 1, wherein the housing is embodied as a single part.

8. Device according to claim 1, wherein the housing has at least one channel for a supply medium of the mechanical seal.

9. Device according to claim 1, wherein the mechanical seal device is a unit that can be preassembled.

10. Device according to claim 1, wherein multiple clamping mechanisms are arranged along a circumference of the mechanical seal device.
